(19) United States
(12) Patent Application Publication
(10) Pub. No.: US 2004/0260780 A1
(43) Pub. Date: Dec. 23, 2004

(54) System, method, and program product for managing messages

(75) Inventor: Jeffrey N Eisen, Waban, MA (US)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY

(21) Appl. No.: 10/464,335

(22) Filed: Jun. 18, 2003

(51) Int. Cl. G06F 15/16

(52) U.S. Cl. 709/207

(57) ABSTRACT

A system, method, and program product for managing messages. Each message includes multiple fields, and each field includes data and a revision identifier. Under the present invention, a recipient may modify one or more fields of a message without his/her modifications being overwritten by an updated message later sent from the originator/sender.

### BACKGROUND OF THE INVENTION

1. Technical Field

The invention relates generally to messaging, and more specifically to messaging that allows recipients to modify the data in fields of a message and selectively update the data when an updated message is received.

2. Related Art

In the modern workplace, events such as meetings are frequently scheduled using electronic messages. Typically, one individual (i.e., the chair) will be in charge of scheduling a meeting to be attended by multiple people. This individual will transmit meeting invitations/messages to each attendee. Unfortunately, attendees of the meeting often have plans for travel, vacation, doctor's appointments, other meetings, etc. that conflict with an initially proposed time and/or date. Further, the location may have to be changed, or the chair may desire to send out additional information about the meeting. Consequently, multiple messages may be received by the attendees before the plans for the meeting are finalized.

One problem with current systems occurs when an attendee desires to make local changes to a message. For example, an attendee may want to add a comment to remember to bring necessary material to the meeting, include an additional description of the location, etc. Some solutions do not allow the attendee to make any changes. For those solutions that do allow such changes, information may be lost when an updated message is received. For example, current solutions either automatically update the old message with the content of the newly received message, thereby losing any changes done by the attendee, or prompt the attendee as to whether they desire to accept the new message or reject it. When the new message is accepted, all the changes done by the attendee are lost, should the new message be rejected, the attendee might inadvertently maintain outdated information. Still further, some solutions require that the attendee keep and compare the original message to a changed message to detect any changes and/or conflicts. However, these solutions require additional data to be saved by each attendee. Moreover, certain data formats are difficult to compare, thus making these solutions more error prone.

Similar problems arise when messaging is used in other situations. For example, an author may send a draft of a document to an editor. The editor may make notations in the draft. Subsequently, the author may send a second draft. If the editor accepts the second draft, the notations in the previous draft would be lost. However, if the editor chooses to continue with the older version, unnecessary (duplicative) work may be performed due to changes made in the newer draft.

As a result, a need exists for a system, method, and program product that allows messages to be modified by a recipient, and allows the recipient to selectively update data for a message when an updated message is received from the sender.

### SUMMARY OF THE INVENTION

In general, the present invention provides a system, method, and program product for allowing recipients of a message to make personal modifications to the message (i.e., modifications stored only in the recipients' copy of the message), and still be able to receive an updated message from an originator without losing their modifications. Under the present invention, each message includes multiple fields, with each field including data and a corresponding “revision” identifier. The revision identifier is modified in a first manner when a change to the corresponding data is made by the recipient, and is modified in a second manner when a change to the corresponding data is made by the originator when creating an updated message. For example, if an originator sends a message to a recipient, the recipient may modify data in one or more of the fields. Doing so would produce a “modified” message and cause the revision identifier for each modified field to be changed in a first manner. If the originator later decides to change data in one or more of the fields of the “original” message, the revision identifiers corresponding to those fields will be changed in a second manner and an “updated” message will be produced. In any event, if the originator and recipient have changed data in different fields, no “conflict” exists and the messages will be automatically merged. That is, if the recipient changed data in field “A” and the originator changed data in field “B,” no conflict exists and recipient will observe a message that includes both his/her modification as well as the update made by the originator. However, if the recipient and the originator changed data in the same (i.e., a common) field, a “conflict” does exist and the recipient is presented with the option of either rejecting or accepting the originators updated message. If the updated message is rejected, the recipient's modifications will be kept intact. Alternatively, if the recipient chooses to accept the updated message, the data in the conflicting field of the updated message can either overwrite the data in corresponding field of the modified message (i.e., overwrite the recipient's modification), or the data in the conflicting fields can be combined.

A first aspect of the invention provides a method of managing messages comprising: receiving a message; modifying the received message; receiving an updated message based on the received message, wherein each message includes a plurality of fields, and wherein each field includes data and a corresponding revision identifier; and merging the modified message and the updated message based on the revision identifier in the updated message and the revision identifier in the modified message.

A second aspect of the invention provides a method of managing messages comprising: generating a message; sending the message from an originator to a recipient; modifying the message by the recipient; generating an updated message based on the message by the originator; sending the updated message to the recipient, wherein each message includes a plurality of fields, and wherein each field includes data and a corresponding revision identifier; and merging the modified message and the updated message based on the revision identifier in the updated message and the revision identifier in the modified message.

A third aspect of the invention provides a system for managing messages comprising: a recipient system that includes: a reception system for receiving a message and an updated message that is based on the received message, wherein each message includes a plurality of fields, and wherein each field includes data and a corresponding revision identifier; and a merger system for merging the received message and the updated message based on the revision identifier in the updated message and the revision identifier in the received message.

A fourth aspect of the invention provides a program product stored on a recordable medium for managing messages, which when executed comprises: program code for receiving a message; program code for modifying the received message; program code for receiving an updated message based on the received message, wherein each message includes a plurality of fields, and wherein each field includes data and a corresponding revision identifier; and program code for merging the modified message and the updated message based on the revision identifier in the updated message and the revision identifier in the modified message.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative system according to one aspect of the invention;

FIG. 2 shows a detailed view of illustrative sender and recipient systems of FIG. 1;

FIG. 3 shows an illustrative message;

FIG. 4 shows an edited message based on the message in FIG. 3;

FIG. 5 shows an updated message based on the message in FIG. 3;

FIG. 6A shows a first illustrative modified message based on the messages in FIGS. 4 and 5;

FIG. 6B shows a second illustrative modified message based on the messages in FIGS. 4 and 5;

FIG. 6C shows a third illustrative modified message based on the messages in FIGS. 4 and 5;

FIG. 7 shows a second updated message based on the message in FIG. 5;

FIG. 8 shows illustrative method steps for determining data according to one aspect of the invention; and

FIG. 9 shows illustrative method steps for selecting data according to one aspect of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the present invention provides a system, method, and program product for allowing recipients of a message to make personal modifications to the message (i.e., modifications stored only in the recipients' copy of the message), and still be able to receive an updated message from an originator without losing their modifications. Under the present invention, each message includes multiple fields, with each field including data and a corresponding “revision” identifier. The revision identifier is modified in a first manner when a change to the corresponding data is made by the recipient, and is modified in a second manner when a change to the corresponding data is made by the originator when creating an updated message. For example, if an originator sends a message to a recipient, the recipient may modify data in one or more of the fields. Doing so would produce a “modified” message and cause the revision identifier for each modified field to be changed in a first manner. If the originator later decides to change data in one or more of the fields of the “original” message, the revision identifiers corresponding to those fields will be changed in a second manner and an “updated” message will be produced. In any event, if the originator and recipient have changed data in different fields, no “conflict” exists and the messages will be automatically merged. That is, if the recipient changed data in field “A” and the originator changed data in field “B,” no conflict exists and recipient will observe a message that includes both his/her modification as well as the update made by the originator. However, if the recipient and the originator changed data in the same (i.e., a common) field, a “conflict” does exist and the recipient is presented with the option of either rejecting or accepting the originators updated message. If the updated message is rejected, the recipient's modifications will be kept intact. Alternatively, if the recipient chooses to accept the updated message, the data in the conflicting field of the updated message can either overwrite the data in corresponding field of the modified message (i.e., overwrite the recipient's modification), or the data in the conflicting fields can be combined.

It should be understood that when messages/data are merged under the present invention, several variations are possible. For example, if an updated message is merged with a modified message, data from the updated message can be copied to the modified message for the recipient to observe, or vice versa. Alternatively, when an updated message is merged with a modified message, the data of both messages can be combined to form a new, distinct message. In any event, the term “merge” is intended to incorporate any possible variation.

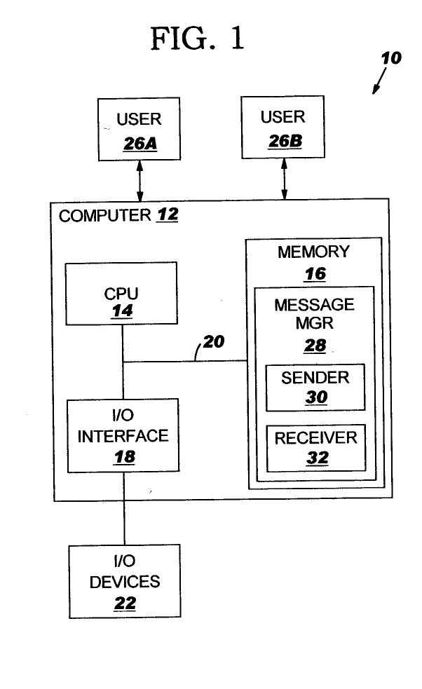

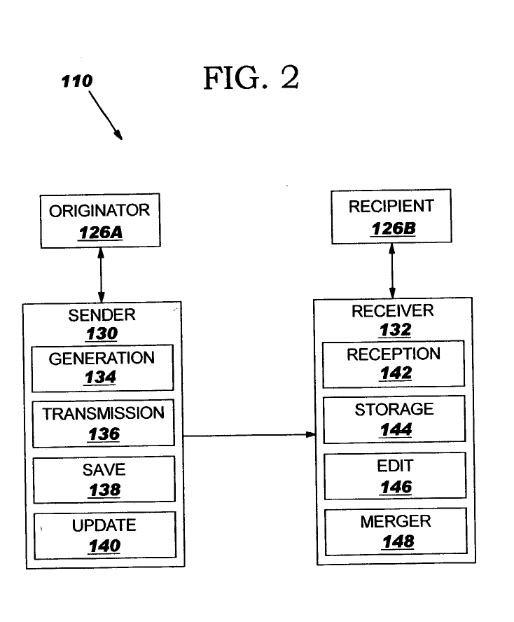

Turning to the drawings, FIG. 1 shows a computerized messaging system 10. Messaging system 10 includes a computer 12 that comprises any type of computer. For example, computer 12 can be a hand-held device (e.g., personal digital assistant, cellular phone, pager device, etc.) or a larger-sized computer system (e.g., laptop, personal computer, workstation, server, etc.). Users 26A, 26B use computerized messaging system 10 by interacting with computer 12. It is understood that each user 26A, 26B could interact using separate computers 12 (as shown in FIG. 2). In this case, each computer 12 would be capable of communicating with one or more other computers over a network. The network can comprise any type of network including the Internet, a wide area network (WAN), a local area network (LAN), a virtual private network (VPN), etc. To this extent, communication can occur via a direct hardwired connection (e.g., serial port), or via an addressable connection in a client-server (or server-server) environment that may utilize any combination of wireline and/or wireless transmission methods. In the case of the latter, the server and client may utilize conventional network connectivity, such as Token Ring, Ethernet, WiFi or other conventional communications standards. Where the client communicates with the server via the Internet, connectivity could be provided by conventional TCP/IP sockets-based protocol. In this instance, the client would utilize an Internet service provider to establish connectivity to the server.

As shown, computer 12 generally includes central processing unit (CPU) 14, memory 16, input/output (I/O) interface 18, bus 20, and external I/O devices/resources 22. CPU 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to CPU 14, memory 16 may reside at a single physical location, comprising one or more types of data storage, or be distributed across a plurality of physical systems in various forms.

I/O interface 18 may comprise any system for exchanging information to/from one or more I/O devices 22. I/O devices 22 may comprise any known type of external device, including speakers, a CRT, LED screen, hand-held device, keyboard, mouse, voice recognition system, speech output system, printer, monitor/display, facsimile, pager, etc. To this extent, it should be appreciated that if computer 12 is a hand-held device, the display would be contained within computer 12, and not as an external I/O device 22 as shown.

Bus 20 provides a communication link between each of the components in computer 12 and likewise may comprise any known type of transmission link, including electrical, optical, wireless, etc. In addition, although not shown, additional components, such as cache memory, communication systems, system software, etc., may be incorporated into computer 12.

Shown in memory 16 is a message manager 28. Message manager 28 is shown including a sender system 30 and a receiver system 32. User 26A can access computer 12 to send a message to user 26B using sender system 30. Sender system 30 provides the required functionality for user 26A to send messages to one or more recipients. Similarly, user 26B can access computer 12 to receive the message sent by user 26A using receiver system 32. To this extent, receiver system 32 provides the required functionality for user 26B to receive messages. While both sender system 30 and receiver system 32 are shown implemented on computer 12, it is understood that either sender system 30 or receiver system 32 may be individually implemented on one or more computers.

FIG. 2 shows a more detailed view of an illustrative sender system 130 and receiver system 132 included as part of a messaging system 110. While only one sender system 130 and receiver system 132 are shown, it is understood that the invention applies to any number of sender systems 130 and receiver systems 132. As depicted, sender system 130 includes a generation system 134, a transmission system 136, a save system 138, and an update system 140, while receiver system 132 includes a reception system 142, a storage system 144, an edit system 146, and a merger system 148. Operation of the each of the systems is discussed with reference to an illustrative implementation of the invention in which messaging is used to schedule a meeting. However, it is understood that the teachings of the invention are not limited to such an implementation. In the meeting example, an originator 126A sends a message and thereafter one or more updated messages to schedule the meeting. Each message is received by at least one recipient 126B, who is allowed to make modifications thereto and thereby produce a “modified” message. While communications are discussed as being “one way” (i.e., from originator to recipient), it is understood that the invention can be used in a “two way” communications environment. For example, originator 126A could be a recipient for a different meeting, and recipient 126B could be an originator for a different meeting.

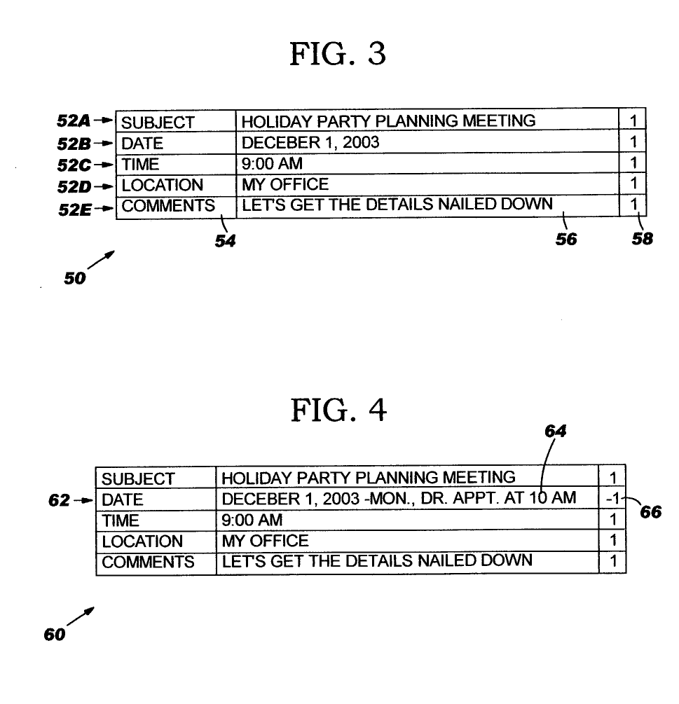

Initially, originator 126A decides to schedule a meeting. In order to inform other participants about the meeting, originator 126A uses sender system 130 to send a message to one or more recipients 126B. To this extent, originator 126A uses generation system 134 to generate the message. FIG. 3 shows an illustrative message 50. As shown, message 50 includes a plurality of fields 52A-E with each field 52A-E including multiple sub-fields. In this example, the sub-fields comprise a title 54, data 56, and a revision identifier 58. When message 50 is being defined, originator 126A provides data for each field 52A-E, and generation system 134 (FIG. 2) automatically sets the revision identifier 58 for each field. In the embodiment shown, each revision identifier 58 is initially set to a value of 1, which means it is the first version of the corresponding data 56. It is understood that message 50 is only one example of a message that can be generated by the current invention. As a result, messages can include more or fewer fields, having the same or different titles, and more or fewer sub-fields.

Returning to FIG. 2, once originator 126A has generated the message, transmission system 136 sends the message to one or more receiver systems 132 for access by one or more recipients 126B. The message is then saved as a sent message by save system 138. Further, the message is received by reception system 142 of each receiver system 132. When reception system 142 determines that the message is an original message (i.e., it is not based on any previously received messages), the message is sent to storage system 144 for storage. Under the present invention, storage system 144 may include one or more storage devices, such as a magnetic disk drive or an optical disk drive. Further, storage system 144 can include data distributed across, for example, a LAN, WAN or a storage area network (SAN) (not shown). In any event, a recipient 126B can view the stored message using edit system 146. It is understood that, while not shown, originator 126A can also be a recipient of the message. In this case, originator 126A would have two copies of the message, the sent message and the stored message. Any modifications made to the copies of the message are treated differently by messaging system 110 as described below.

Frequently, recipient 126B may want to make modifications to the message that was received. These modifications may be personal to each recipient 126B, and are not shared with other users. Edit system 146 allows recipient 126B to modify data 56 (FIG. 3) in one or more fields 52A-E (FIG. 3) of the received message. FIG. 4 shows a modified message 60 that is based on message 50 (FIG. 3). In particular, data 64 for date field 62 has been modified to include a note about a doctor's appointment that recipient 126B (FIG. 2) has on the same date. Further, once data 64 was modified, edit system 146 (FIG. 2) adjusted the corresponding revision identifier 66 in a certain manner by making it a negative value (i.e., −1). By adjusting revision identifier 66 in this manner, receiver system 132 (FIG. 2) can readily detect which fields (if any) of message 50 (FIG. 3) have been modified by recipient 126B (FIG. 2).

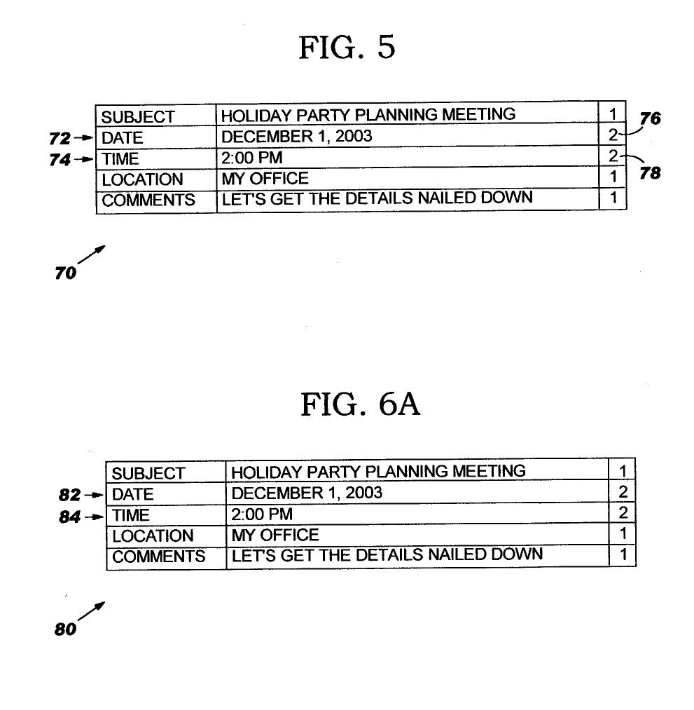

Returning to FIG. 2, if originator 126A later decides to reschedule the meeting for a different time, update system 140 is used to change the data in the sent message that was stored using save system 138. FIG. 5 shows an illustrative updated message 70 that is based on message 50 shown in FIG. 3. In updated message 70, originator 126A (FIG. 3) has modified data in both a time field 74 (to change the scheduled time), and a date field 72 (to correct a previous misspelling of “December”). As a result, the corresponding revision identifiers 76, 78 for fields 72, 74 respectively, have been incremented by one to indicate that the data has changed from the previous version (i.e., original message 50 shown in FIG. 3). By adjusting the revision identifiers in this manner, the revision that corresponds to the data in the field can quickly be determined. Thus, in a typical embodiment, the revision identifiers are adjusted in a different manner for originator 126A and recipient 126B. It should be appreciated, however, that in an alternative embodiment the revision identifiers could be adjusted in the same manner for originator 126A and recipient 126B.

In any event, once originator 126A has finished making the desired modifications, updated message 70 (FIG. 5) is sent using transmission system 136, and is itself saved as a sent updated message using save system 138. When reception system 142 receives updated message 70, it can determine that updated message 70 is based on a previous message by, for example, checking a “message” identifier in the message. Each message can include a message identifier that includes information on whether it is an original or modified message. When the identifier indicates that it is a modified message, an identification of the previous message on which it is based can also be included. If the previous message has already been received, then the message is treated as an updated message. Otherwise it is treated as an original message as described above. An updated message may be treated as an original message when, for example, the two messages are received out of order, or when a new recipient is added to the list of recipients after the original message was sent.

When an updated message is received, reception system 142 forwards the updated message to merger system 148. Merger system 148 can merge the previously received and/or modified message (i.e., message 60 shown in FIG. 4) with the updated message based on the revision identifiers. In particular, the revision identifiers are used to determine whether the corresponding data has been changed from a previous version by originator 126A and/or recipient 126B. Various options exist depending on whether and by whom the data was changed.

In the case where the previous message was not modified by recipient 126B (i.e., all revision identifiers are positive), the previous message can be updated/replaced with the modified message. However, when the previous message has been changed by recipient 126B, the action(s) to be taken depend on whether any “conflicts” are present. As indicated above, a conflict exists when both originator 126A and recipient 126B update/modify the same field. To this extent, when a particular field has not been modified by both originator 126A and recipient 126B, no conflict is present for that field. In this case, the data in the updated message will be automatically merged with the data in the modified message. For example, in comparing FIGS. 4 and 5, it can be seen that no conflict exists with respect to the time field. That is, only originator changed the time field. Accordingly, upon receiving updated message 70, merger system 148 will automatically use the time set forth in updated message 70 (e.g., 2:00 PM).

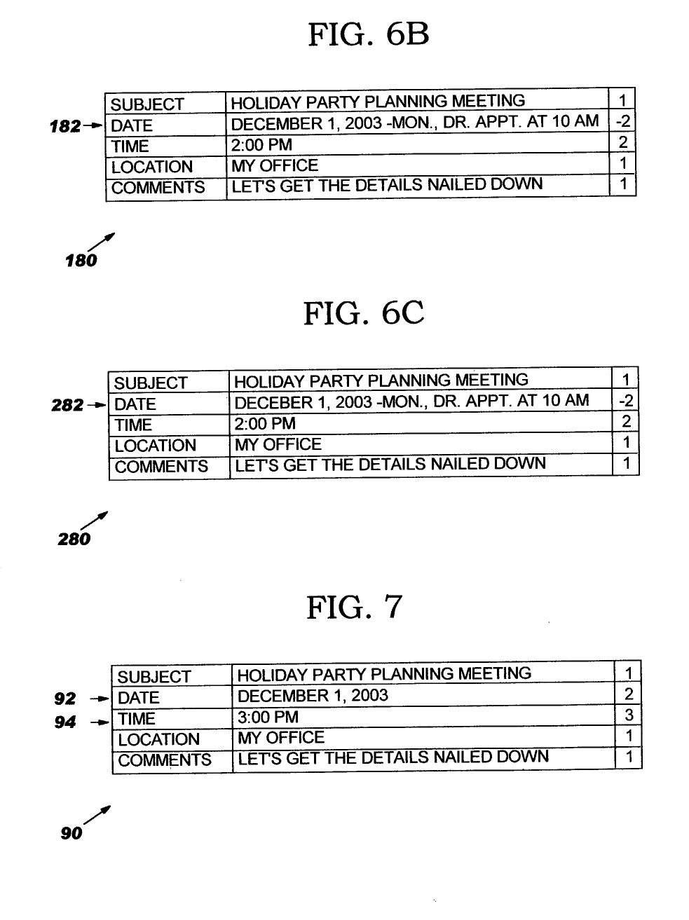

However, where both originator 126A and recipient 126B update/modify the same field, a conflict is present for that field. In general, the conflict could be resolved based on input from recipient 126B. For example, as shown in FIGS. 4 and 5, both originator 126A and recipient 126B have changed data in date field 62 and 72, respectively. When such a conflict arises, recipient 126B can be prompted to accept or reject updated message 70. If the updated message 70 is accepted, multiple options are available to recipient 126B. First, recipient 126B could allow the data in the conflicting field of updated message 70 to overwrite the data in the corresponding field of modified message 60. As will be further explained below, FIG. 6A shows the result of recipient 126B allowing the conflicting data on updated message 70 to overwrite the corresponding data in modified message 60. As depicted, message 80 not only includes the new time in (the non-conflicting) time field 84, but it also includes the date as corrected by originator 126A in date field 82. Thus, by allowing overwrite to occur, recipient 126B is permitting his/her personal modifications to be discarded. Alternatively, recipient 126B can allow the data in conflicting fields to be combined/merged. As shown in FIG. 6B, message 180 not only includes the new time, but it also includes both the corrected spelling of December as well as recipient 126B's personal note. If, however, the updated message 70 is rejected by recipient, field 62 of modified message 60 will be left intact (although any non-conflicting changes made by originator 126A (e.g., the time) will be merged). FIG. 6C shows the results of recipient 126B's rejection of updated message 70. As can be seen, although message 280 of FIG. 6C includes the updated time, date field 282 is left as it appeared in modified message 60.

In general, conflicts can be detected by review of the revision identifiers. For example, upon receiving updated message 70, reception system 142 will detect that the revision identifiers 76 and 78 for fields 72 and 74 have been adjusted. Similarly, reception system can review the revision identifiers for modified message 60 (e.g., as stored in storage system 144) to detect that field 62 has been modified. Where corresponding fields of modified message 60 and updated message 70 have been modified/updated, a conflict is identified. It should be appreciated that a conflict could be detected when originator 126A and recipient 126B make the same change. In this case, no input from recipient 126B need be required.

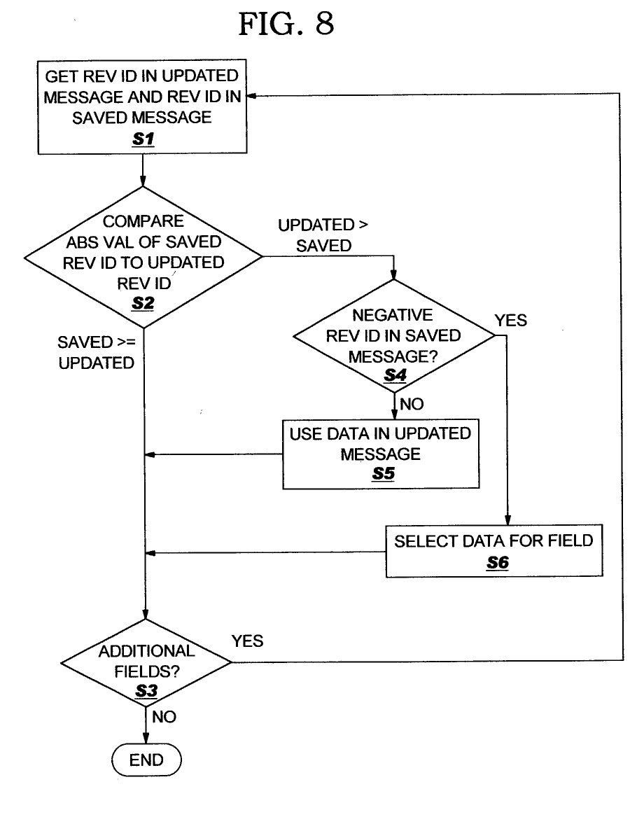

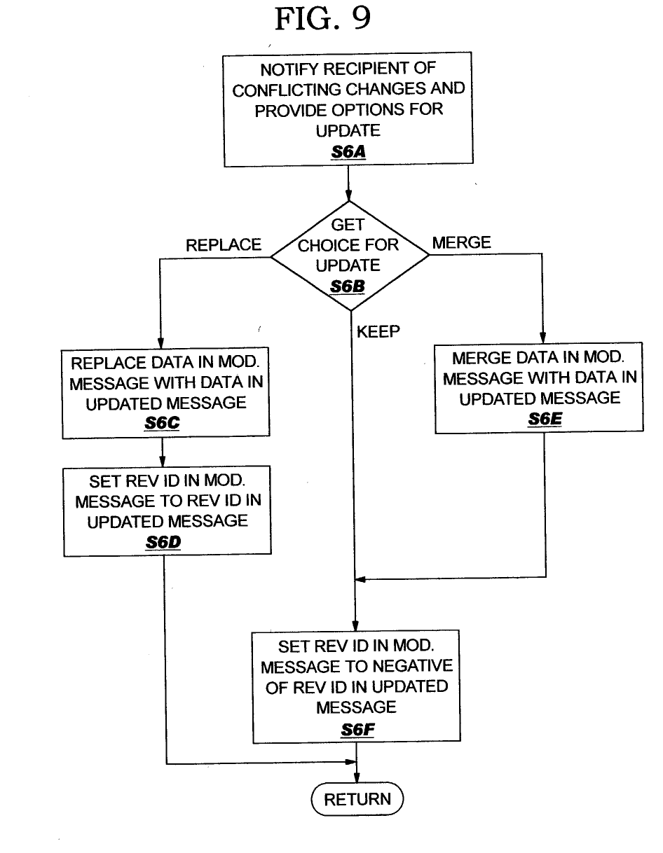

Referring now to FIGS. 8 and 9, the above-described scenarios will be described in further detail. Specifically, FIG. 8 shows illustrative method steps for merging the data of a modified message with an updated message using merger system 148 (FIG. 2). In step S1, the revision identifiers for a field in the updated message and the saved message (i.e., saved in storage system 144) are retrieved. The saved message can either be the “original” message, or a modified message (i.e., the original message as modified by recipient 126B). In any event, in step S2, the absolute value of the saved message revision identifier is compared to the revision identifier for the updated message. In one embodiment, each revision identifier for the updated message will always have a positive value since its value is initially set at 1 and it is incremented for each updated message. As a result, there is no need to compare its absolute value. Regardless, if the two values are the same, then no action is required for the field. Because in this case, one of two possibilities is true; the data for the field has not been changed by the originator or the recipient, or the data for the field was modified by the recipient and not the originator. In the case of the former, the data is already the same between the two messages, while in the latter case, the field already includes a desired modification from the current data. Additionally, if the absolute value of the saved message revision identifier is greater than the updated message revision identifier, then no action is required for the field. In this case, the messages were received out of order. As a result, the saved message is a newer revision then the later received message. In any case, flow continues to step S3 to determine if any additional fields are present in the updated message. If at least one additional field is present, control is returned to step S1, otherwise the process ends. Alternatively, when the absolute value of the saved message revision identifier is greater than the updated message revision identifier, the process could end, bypassing any remaining fields.

When the comparison in step S2 determines that the absolute value of the saved message revision identifier is less than the updated message revision identifier (e.g., 1 and 2, respectively), control passes to step S4. In step S4, it is determined whether the revision identifier for the field in the saved message is negative. If the value is not negative, then the data in the field has not been modified by the recipient. As a result, control passes to step S5 in which the data for the field in the updated message is automatically used. However, when the value is negative, both the originator and the recipient have made modifications to the data in the field and a conflict exists. In this case, control passes to step S6 wherein the data for the field is selected based on the data for both fields. In either case, once processing for the field is complete, control passes to step S3 to determine if any additional fields are present in the updated message.

In step S6, selection of the data can comprise any one of numerous methods. FIG. 9 shows illustrative method steps for selecting the data for a field according to one embodiment of the invention. In step S6A, the recipient is notified that both the recipient and the originator have made changes to the data of a particular field. Further, the recipient is provided with multiple options for updating the data. In step S6B, the option that the recipient desires is retrieved. As explained above, the recipient can choose to replace the data for the field in the modified message with the data for the field in the updated message, combine the data for the field in both messages, or keep the data for the field in the modified message (i.e., reject the updated message).

When the recipient decides to replace the data, control is passed to steps S6C-S6D. In step S6C, the data for the field in the modified message is replaced with the data for the field in the updated message. In step S6D, the revision identifier for the modified message is also updated to the revision identifier in the updated message since the data for the field in the modified message now matches the data for the field in the updated message. FIG. 6A shows an illustrative modified message 80 that results from replacing the data for field 62 in modified message 60 (FIG. 4) with the data for field 72 in updated message 70 (FIG. 5). Specifically, the data in field 82 comprises the data from field 72 (FIG. 5) since the recipient agreed to accept the originator's typo change in the date field, even though it overwrote the note about a doctor's appointment. Conversely, the data for field 84 is automatically changed since the data for the time field in modified message 60 (FIG. 4) has not been changed by the recipient. As shown, both the data and revision identifiers for fields 82, 84 are the same as those for fields 72, 74, respectively, in updated message 70 (FIG. 5).

Returning to FIG. 9, when the recipient decides to combine the data in step S6B, control passes to step S6E. In step S6E, the data for the field in the modified message is combined with the data for the field in the updated message. Various options are possible for combining the data. For example, the data can be combined by concatenating the content of one to the other, or by performing a difference operation and allowing the user to select which modifications to save in the data for the modified message. FIG. 6B shows an illustrative modified message 180 that results from combining the data for field 62 in modified message 60 (FIG. 4) with the data for field 72 in updated message 70 (FIG. 5). As shown, the data for field 182 in modified message 180 includes both the corrected typo from the data for field 72 in updated message 70 (FIG. 5) and the personal note from the data 64 for the corresponding field 62 in stored message 60 (FIG. 4). As with before, the data for the time field in modified message 180 is automatically set to include the data from time field 74 in updated message 70 (FIG. 5).

Returning to FIG. 9, after the data for the field in the modified message and updated message have been combined, control passes to step S6F. In step S6F, the revision identifier in the modified message is set to the negative of the revision identifier in the updated message. Since the recipient decided to combine the data of the modified message and updated message, the data for the field in the modified message remains different from what was sent in the updated message. Step S6F is also performed when the recipient chooses to keep the data for the field in the modified message (i.e., rejects the changed data in the updated message). FIG. 6C shows an illustrative stored message 280 having a field 282 that results from keeping the data for field 62 in modified message 60 (FIG. 4). As shown in both FIGS. 6B and 6C, the revision identifiers for fields 182, 282 in stored messages 180, 280, respectively, have been set to the negative of the revision identifier for field 74 in updated message 70 (FIG. 5).

By setting the revision identifier to the negative of the updated message revision identifier in step S6F, the recipient is not notified of a conflict when another updated message is received that does not modify the field. However, the recipient is notified of a conflict when another update message is received that does modify the field. For example, FIG. 7 shows a second updated message 90 based on updated message 70 (FIG. 5). In updated message 90, field 94 has been modified while field 92 remains the same. When updated message 90 is compared with either stored message 180 (FIG. 6B) or stored message 280 (FIG. 6C), field 92 includes different data than stored fields 182, 282, respectively. However, the recipient has already accepted the difference. Since the revision identifier for fields 182, 282 is the negative of the revision identifier for field 92, the recipient will not be notified of a conflict between the fields for a second time. Should a later update message be received in which the date field has been modified again (i.e., revision identifier is 3), then the recipient would be notified of a conflict.

It is understood that the method steps shown are only illustrative of the numerous combinations of options that can be presented. For example, the options can be limited to replace or keep the data. Further, the recipient can choose an option that is always applied to conflicts in data in the field so that no notification is provided when the conflict is detected. Additionally, it is understood that the various options for merging the data can be presented as multiple options to the recipient. Still further, it is understood that additional functionality can be provided in addition to that discussed above. For example, an originator can mark a field as being “important,” and can be automatically notified if a recipient rejects the update. Further, additional electronic communications can be provided that can be initiated by recipients and/or the originator by using alternative messages that do not include fields (e.g., email, voicemail, etc.).

While the revision identifier has been shown and described as an integer, it is understood that the revision identifier can comprise any solution that is capable of distinguishing between changes made by two parties. For example, the revision identifier could comprise two Boolean values, one to indicate a change by the originator and the second to indicate a change by the recipient. When a solution incorporates the advantages of integers (i.e., sequential values, ability to mark as changed without adversely affecting version comparison), additional functionality can be incorporated. For example, by incrementing each change performed by the originator, it can be assured that updated messages are handled in the appropriate order (i.e., increasing values) or that an older updated message is not processed after a newer updated message for a particular field. The ability to determine the order of updated messages may be important when numerous updated messages are sent and/or the messages are sent over a distributed network such as the Internet in which messages can be received out of order.

It should be understood that the present invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of various embodiments of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of managing messages comprising:
receiving a message;
modifying the received message;
receiving an updated message based on the received message, wherein each message includes a plurality of fields, and wherein each field includes data and a corresponding revision identifier; and
merging the modified message and the updated message based on the revision identifier in the updated message and the revision identifier in the modified message.

2. The method of claim 1, wherein the modifying step includes:
changing data for at least one field in the received message; and
automatically adjusting the revision identifier for the at least one field in a first manner.

3. The method of claim 2, further comprising:
generating the message;
sending the message to a recipient; and
storing the sent message.

4. The method of claim 3, wherein the generating step includes:
obtaining data for each field in the message; and
automatically setting the revision identifier for each field.

5. The method of claim 3, further comprising:
creating the updated message by changing data for at least one field in the sent message;
automatically adjusting the revision identifier for the at least one field in a second manner; and
sending the updated message to the recipient.

6. The method of claim 1, wherein the merging step includes for each field in the updated message:
comparing the revision identifier in the updated message to the revision identifier in the modified message; and
updating the data in the modified message with the data in the updated message when the data in the updated message has been changed and the data in the modified message has not been modified.

7. The method of claim 6, wherein the merging step further includes for each field in the updated message:
selecting the data for the modified message based on the data in the updated message and the data in the modified message when the data in the updated message has been changed and the data in the modified message has been modified.

8. The method of claim 7, wherein the selecting step includes:
notifying the recipient of a conflict;
obtaining an update choice from the recipient; and
updating the modified message, wherein the updating step includes one of: using the data in the updated message, using the data in the modified message, and combining the data in the updated message with the data in the modified message.

9. A method of managing messages comprising:
generating a message;
sending the message from an originator to a recipient;
modifying the message by the recipient;
generating an updated message based on the message by the originator;
sending the updated message to the recipient, wherein each message includes a plurality of fields, and wherein each field includes data and a corresponding revision identifier; and
merging the modified message and the updated message based on the revision identifier in the updated message and the revision identifier in the modified message.

10. The method of claim 9, wherein the modifying step includes:
changing data for at least one field in the message; and
automatically adjusting the revision identifier for the at least one field in a first manner.

11. The method of claim 10, wherein the generating an updated message step includes:
changing data for at least one field in the message; and
automatically adjusting the revision identifier for the at least one field in a second manner.

12. The method of claim 9, wherein the merging step includes for each field in the updated message:
comparing the revision identifier in the updated message to the revision identifier in the modified message;
updating the data in the modified message with the data in the updated message when the data in the updated message has been changed and the data in the modified message has not been modified; and
selecting the data for the modified message based on the data in the updated message and the data in the modified message when the data in the updated message has been changed and the data in the modified message has been modified.

13. A system for managing messages comprising:
a recipient system that includes:
a reception system for receiving a message and an updated message that is based on the received message, wherein each message includes a plurality of fields, and
wherein each field includes data and a corresponding revision identifier; and
a merger system for merging the received message and the updated message based on the revision identifier in the updated message and the revision identifier in the received message.

14. The system of claim 13, wherein the recipient system further includes an edit system for allowing a recipient to modify data in one or more fields in the received message and automatically adjusting the corresponding revision identifier for the edited data in a first manner.

15. The system of claim 14, further comprising:
a sender system that includes:
a generation system for generating the message; and
a transmission system for sending the message to at least one recipient.

16. The system of claim 15, wherein the sender system further includes:
an update system for allowing a sender to create the updated message by modifying data in one or more fields in the sent message and automatically adjusting the corresponding revision identifier in a second manner, wherein the transmission system sends the updated message to at least one recipient.

17. The system of claim 13, wherein the merger system merges data for each field in the modified message with the data in the updated message by comparing the revision identifier in the updated message to the revision identifier in the modified message.

18. The system of claim 17,wherein the merger system updates the data in the modified message with the data in the updated message when the data in the updated message has been changed and the data in the modified message has not been modified.

19. The system of claim 17, wherein the merger system allows the recipient to select the data for the modified message when the data in the updated message has been changed and the data in the modified message has been modified.

20. A program product stored on a recordable medium for managing messages, which when executed comprises:
program code for receiving a message;
program code for modifying the received message;
program code for receiving an updated message based on the received message, wherein each message includes a plurality of fields, and wherein each field includes data and a corresponding revision identifier; and
program code for merging the modified message and the updated message based on the revision identifier in the updated message and the revision identifier in the modified message.

21. The program product of claim 20, further comprising:
program code for generating the message, wherein the revision identifier for each field is set to an initial value;
program code for sending the message to the recipient;
program code for creating the updated message by changing data for at least one field in the sent message;
program code for automatically adjusting the revision identifier for the at least one field in a first manner; and
program code for sending the updated message to the recipient.

22. The program product of claim 21, wherein the program code for modifying includes:
program code for changing data for at least one field in the received message; and
program code for automatically adjusting the revision identifier for the at least one field in a second manner.

23. The program product of claim 22, wherein the program code for merging includes:
program code for comparing the revision identifier in the updated message to the revision identifier in the modified message;
program code for updating the data in the modified message with the data in the updated message when the data in the updated message has been changed and the data in the modified message has not been modified; and
program code for selecting the data for the stored message based on the data in the updated message and the data in the modified message when the data in the updated message has been changed and the data in the modified message have been modified.
